(19) United States
(12) Patent Application Publication
(10) Pub. No.: US 2010/0217531 A1
(43) Pub. Date: Aug. 26, 2010

(54) HYDROCARBON MEASUREMENT STATION PREVENTATIVE MAINTENANCE INTERVAL DETERMINATION

(75) Inventor: Donald M. Day, Cypress, TX (US)

Correspondence Address: CONLEY ROSE, P.C.;David A. Rose, P. O. BOX 3267, HOUSTON, TX, 77253-3267, US

(73) Assignee: DANIEL MEASUREMENT AND CONTROL, INC., Houston, TX (US)

(21) Appl. No.: 12/393,129

(22) Filed: Feb. 26, 2009

(51) Int. Cl. G01V 1/40

(52) U.S. Cl. 702/13

(57) ABSTRACT

Hydrocarbon measurement station preventative maintenance interval determination. At least some of the illustrative embodiments are measurement stations configured to measure volumetric flow of hydrocarbons, where the measurement stations include a flow meter fluidly coupled to a piping system configured to carry at least one type of hydrocarbon flow, and a computer system comprising an interface device (the computer system electrically coupled to the flow meter and the computer system configured to maintain a plurality of parameters related to the volume of hydrocarbon flow in the piping). The computer system is configured to provide maintenance information for the measurement station, and the computer system provides the maintenance information at intervals determined based on constituents of hydrocarbons and based on parameters related to the volume of hydrocarbon flow in the piping.

### BACKGROUND

Manufacturers of distributed process control systems design their control systems to be used with a variety of industrial processes. For example, the general hardware and software that a distributed process control system manufacturer creates may be used in such diverse applications as running a power plant to controlling a food processing facility. For this reason, the manufacturers of distributed process control systems intentionally create their systems to be easily adaptable to a plurality of different controlled processes.

However, there are niche markets in the process control realm for which general process control systems are not particularly suited. For example, the measurement of the flow of hydrocarbons (e.g., natural gas, liquefied natural gas, oil, gasoline) for purposes of custody transfer is a niche market for which the general tools provided in a distributed process control system are inadequate. Stated otherwise, while some distributed process control systems may have function blocks to perform flow measurement calculations, the flow measurement calculations provided are not of sufficient accuracy for custody transfer (i.e., billing) purposes. Moreover, many legal jurisdictions have regulatory audit requirements regarding the measurement of the flow of hydrocarbons, and the general tools for flow measurement calculations of process control systems do not meet such requirements.

Because of the complexity and requirements regarding measurement of hydrocarbons for custody transfer, in the related art measurement stations are separate physical systems in the overall control scheme. Moreover, because the flow volume and constituent components of the hydrocarbons differ from system-to-system, measurement stations are in most cases specially designed or one-of-kind systems built to customer-provided specifications. Because of the variance between measurement stations and the general one-of-kind nature of such stations, in many cases the measuring station is merely a run-to-failure system, with very often no or very little preventative maintenance performed, aside from general instrument calibration.

### BRIEF DESCRIPTION OF THE DRAWINGS

For a detailed description of exemplary embodiments, reference will now be made to the accompanying drawings in which:

FIG. 1 illustrates a measurement station in accordance with at least some embodiments;

FIG. 2 illustrates applying the information contained in Table 1 in accordance with at least some embodiments;

FIG. 3 shows an illustrative set of applications and databases for a measurement station in accordance with at least some embodiments;

FIG. 4 shows a method in accordance with at least some embodiments; and

FIG. 5 shows a processing unit in accordance with at least some embodiments.

### NOTATION AND NOMENCLATURE

Certain terms are used throughout the following description and claims to refer to particular system components. As one skilled in the art will appreciate, manufacturers of measurement station equipment may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

“Constituents of hydrocarbons” shall mean either the type or types of hydrocarbon molecules present, or the presence and characteristics of other materials (e.g., water, sand, wax, sulfides (e.g., H₂S)) entrained or otherwise with the hydrocarbons.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

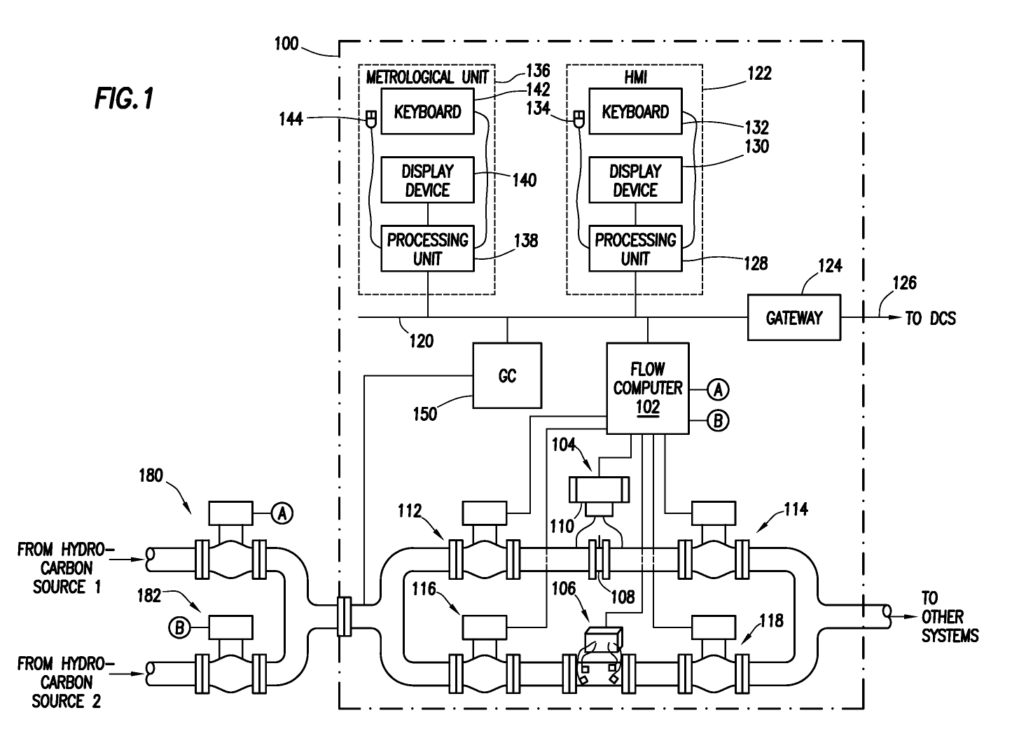

FIG. 1 shows an illustrative measurement station 100. In particular, the measurement station 100 comprises a flow computer 102 coupled to a plurality of meter devices 104 and 106. In the exemplary embodiments of FIG. 1, meter device 104 is illustrated as an orifice plate 108 coupled to a differential pressure transducer 110. Meter device 106 is illustrated as an ultrasonic flow meter. However, flow calculations based on differential pressure across an orifice plate, or by an ultrasonic meter, are merely illustrative of any meter device that may be used to measure hydrocarbon flow (e.g., differential pressure flow meters, ultrasonic flow meters, turbine-type flow meters, and Coriolis meters).

The measurement station 100 is illustrated as having two meter runs, the first meter run using meter device 104 and the second meter run using meter device 106. Where a broad range of flow volumes are expected, more meter runs may be implemented, or different sizes may be used, and where relatively constant flow volumes are expected, a single meter run may be sufficient. In most situations, the type of meter devices 104 and 106 are similar, with characteristics of each meter device 104 and 106 (e.g., meter diameter) selected for particular flow volumes. In some cases the measurement station 100 may select which (or both) meter run is utilized at any one time. In such cases, the measurement station 100 may comprise a plurality of control valves, such as control valves 112, 114, 116 and 118. Consider, as an example, that at very high flow volumes the meter run comprising meter device 104 is used. In such an example situation, control valves 112 and 114 will be opened, and control valves 116 and 118 will be closed. Thus, the hydrocarbon flow through the measurement station 100 will flow through the meter device 104. Further consider that, as hydrocarbon flow decreases, better metering accuracy is achieved with the meter device 106, and thus valves 116 and 118 may be opened, and valves 112 and 114 closed such that the hydrocarbons flows through the meter device 106.

In accordance with at least some embodiments, each meter device communicatively couples to a flow computer. In the illustrative embodiments of FIG. 1, the meter devices 104 and 106 communicatively couple to flow computer 102. While only one flow computer 102 is illustrated, measurement stations 100 may have a plurality of flow computers, particularly in stations having many meter runs. The flow computer 102 may receive either instantaneous flow values from the meter devices (e.g., ultrasonic meters, turbine meters) or may receive raw input values from which flow values are calculated (e.g., for flow measurement based pressure drop across an orifice plate: differential pressure: temperature of the hydrocarbons; and upstream pressure). The flow computer 102 may accumulate (sum) the instantaneous flow values provided or calculated to produce total flow values over a predetermined period of time.

The flow computer 102 communicatively couples to a backbone communication network 120. Over the network 120, the flow computer 102 may exchange data values, such as total flow values, with other devices. Moreover, programming and monitoring of the flow computer 102, and/or any of its calculated or accumulated values, may take place across the backbone communication network 120. The flow computer 102 may be, for example, a Daniel® S600 Flow Computer available from Emerson Process Management of St. Louis, Mo. Likewise, the metering device 104 and 106, in their many forms, may also be available from Emerson Process Management.

The illustrative measurement station 100 may also comprise a human/machine interface (HMI) 122 coupled to the backbone communication network 120. As the name implies, the human/machine interface 122 may be the mechanism by which a user interfaces with the equipment of the measurement station 100. For example, the human/machine interface 122 may be the mechanism by which an operator monitors parameters of the hydrocarbon flow through the measurement station 100. The human/machine interface 122 may comprise a processing unit 128 that couples to a display device 130, such as a cathode ray tube (CRT) or liquid crystal display (LCD). The human/machine interface 122 may also have a keyboard 132 and a pointing device 134 coupled thereto, to enable a user to interface with the application programs executing on the processing unit 128. A processor in the processing unit 128 executes programs which transform the processing unit 128 into a special purpose computer, here a special purpose computer to act as a human/machine interface within a hydrocarbon measurement station.

The illustrative measurement station 100 further comprises a metrological unit 136 coupled to the backbone communication network 120. The metrological unit 136 may perform many functions. For example, in some embodiments the metrological unit 138 interfaces with the flow computer 102 over the backbone communication network 120 to perform supervisory control over the flow computer 102. In other embodiments, the flow computer 102 may be omitted, and the metrological unit 136 may communicate directly with meter devices 104 and 106 (such as when the meter devices are ultrasonic flow meters) over the backbone communication network 120. In the alternative embodiments where flow computers are omitted, the metrological unit 136 may be configured to implement flow computer functionality, and as such may be considered to implement one or more virtual flow computers. The metrological unit 136 may provide a centralization of metering data, and may also provide measurement station specific functions, such as station total flow computation from underlying stream totals, flow weighted averaging, long and short term metering reports, and performance of diagnostic checks of the measurement station (e.g., Daniel® MeterLink Condition Based Monitoring Suite available from Emerson Process Management). Although only one metrological unit 136 is illustrated in FIG. 1, any number of metrological units 136 may be implemented to perform the various illustrative functions.

Many legal jurisdictions (e.g., countries where natural resources are government owned) have specific metrological audit requirements regarding metering of hydrocarbons for custody transfer. In accordance with some embodiments, the metrological unit 136 also conforms the hydrocarbon metering aspects to metrological audit requirements. In particular, the metrological unit 136 may perform meter functions dictated by metrological approvals (e.g., prover alignment, prover de-alignment, meter run control to regulate flow to achieve flow through each meter within a linear range). Further still, the metrological unit 136 may be the central repository for metrologically required audit trails (e.g., recording all changes in accordance with metrological requirements). As will be discussed more below, the metrological unit 136 may also perform calculations as to the current state of the measurement station 100 from a preventative maintenance standpoint.

The metrological unit 136 may comprise a processing unit 138, which may be similar in form and construction to the processing unit 128 of the human/machine interface 122. The processing unit 138 may differ from the other processing units by the type and number of application programs and/or a different operating system. Processing unit 138 couples to a display device 140, such as a CRT or LCD display. The metrological unit 136 may also have a keyboard 142 and a pointing device 144 coupled thereto, to enable a user to interface with the application programs executing on the processing unit 138. A processor in the processing unit 138 executes programs which transform the processing unit 138 into a special purpose computer, here a special purpose computer to act as a metrological unit within a hydrocarbon measurement station.

Still referring to FIG. 1, the illustrative measurement station 100 may further comprise a gas chromatograph (GC) 150. The gas chromatograph 150 is a device which analyzes the hydrocarbons to give a breakdown of the hydrocarbon components, BTU content, and the like. The gas chromatograph 150 may communicatively couple to the backbone communication network 120, and thus the parameters determined by the gas chromatograph may be utilized by other devices within the measurement station 100, such as the metrological unit 136, human/machine interface 122 and/or the flow computer 102. The gas chromatograph 150 may be, for example, a Daniel® Danalyzer™ Model 700 gas chromatograph available from Emerson Process Management.

As mentioned above, in many cases the manufacturer of a distributed control system (DCS) to which the measurement station 100 couples is different than the manufacturer of the measurement station 100. Because each manufacturer operates a different protocol on their respective backbone communications network, direct coupling of the backbone communication network 120 to the DCS may not be possible. Thus, gateway unit 124 may act as the mechanism through which data values are exchanged between the measurement station and the DCS. More particularly still, the exchange of values between the measurement station and the DCS takes place over a dedicated communications channel 126 different than the backbone communication network 120. The physical layer of the communication channel 126, as well as the communication protocol utilized, may vary. For example, the communication channel 126 may be a Modbus remote terminal unit (Modbus RTU) interface, Modbus-TCP, or an OPC Specification compliant communication channel. The communication channel 126 may couple to one of the distributed processing units of the DCS. The communication channel 126 is merely a channel to communicate data values, and other control-type functions, such as programming of function blocks, cannot take place over the communication channel 126. The gateway 124 may be a processing unit with a processor that executes software such that the processing unit is a special purpose machine to act as gateway between a hydrocarbon measurement station and a DCS.

The discussion to this point has implicitly assumed that the constituents of hydrocarbons flowing through the measurement station 100 are relatively constant. However, in some circumstances the constituents of hydrocarbons flowing through the measurement station 100 may change depending on the operational situation. For example, the measurement station 100 may measure the flow of refined gasoline for a period of time. Thereafter, the flow of refined gasoline may cease, and instead a flow of refined diesel may be measured for a period of time. As yet another example, the measurement station 100 may measure the flow of natural gas from a first field for a period of time. Thereafter, the flow of natural gas from the first field may cease, and the natural gas from a second field may be measured for a period of time, with the natural gas from the different fields having different constituents. Thus, the measurement station 100 may receive inputs from outside the measurement station such that a change in source may be noted by the measurement station 100. In the illustrative case of FIG. 1, the flow computer 102 communicatively couples to valves 180 and 182 that are external to the measurement station 100. By way of the communicative coupling, the flow computer 102, and thus the measurement station 100 in general, may know when there is a change of source of the hydrocarbons flowing through the measurement station 100. The flow computer 102 does not necessarily control illustrative valves 180 and 182; rather, the flow computer 120 may merely determine the state of each value (e.g., open or closed) by monitoring electrical contacts within the valve controller. In other embodiments, the flow computer 102 may control the external valves based on commands received from other devices (e.g., commands received through the gateway 124).

Measurement stations are, in most cases, built to customer-provided specifications. While the measurement station manufacturer may have a general idea of the hydrocarbons that will flow in the measurement station, the precise constituents of the hydrocarbons may not be known. However, the constituents of hydrocarbons directly affect how often preventative maintenance should be performed on the various components of the measurement station. For example, natural gas flow from a hydrocarbon producing reservoir has not only the hydrocarbons, but may also have varying amounts of entrained sand, entrained water, and hydrogen sulfide, to name a few. Sand has an abrasive effect that accelerates wear of components of the measurement station, and also may clog smaller diameter fluid pathways, such as sensing lines for pressure transmitters. Further, different sands have different effects. For example, white sand clogs differently that clay-based sand. Sulfides, like hydrogen sulfide, tend to adhere to pipe and sensing line walls, restricting flow and causing turbulence in the flow. Some refined products, like butane and propane, may be substantially free from sand and water, but the butane and propane themselves having a drying effect on seals.

Moreover, while a measurement station manufacturer may have a general idea as to the physical location of the measurement station, the precise atmospheric conditions in which the measurement station is to operate may not be known to the measurement station manufacturer. The atmospheric conditions in which the measurement station operates affects how often preventative maintenance should be performed on various components. In corrosive environments, for example, the contacts within electrical plugs and connectors may, on an accelerated basis, develop high resistance because of corrosion. In moist environments water may precipitate or accumulate on electronic components, which may itself then lead to corrosion. In dusty environments, dust may coat electrical components and filters, which affects heat transfer and air flow.

Further still, the manner in which the measurement station is utilized may affect how often maintenance should be performed. For example, a measurement station that continuously measures hydrocarbon flow at a particular pressure may not require preventative maintenance as often as a measurement station that is pressured and de-pressured many times a day. Such cyclic pressure service may adversely affect the operational longevity of devices of the measurement station.

Due in part to the wide variety of constituents of the hydrocarbons, the wide variety of atmospheric conditions, the wide variety of potential operational modes, and the fact most measurement stations are built to purchaser-provided specifications, measurement station manufacturers have not provided their measurement stations with the functionality to determine, based on the factors recited above, that preventative maintenance is indicated for at least one component. Determinations that preventative maintenance is needed based on the factors such as constituents of the hydrocarbons, atmospheric conditions, and operational characteristics should not be be confused with information provided by programs such the Daniel® MeterLink Condition Based Monitoring Suite, which make determinations regarding maintenance based on changes operational characteristics of the meters themselves (e.g., turbulence of gas flow within an ultrasonic meter, or loss of signal from a sensor, among others).

In accordance with the various embodiments, the measurement station 100 monitors parameters of hydrocarbon flow through the measurement station, and based on the parameters of the hydrocarbon flow, the constituents of the hydrocarbons, atmospheric conditions, and operational modes, the measurement station determines when preventative maintenance is needed for at least one component of the measurement station and provides an indication of the determination (e.g., on an operator interface of the measurement station). Parameters of the hydrocarbon flow upon which a preventative maintenance decision may be based may comprise parameters such as the amount of time of hydrocarbon flow through the measurement station since the last preventative maintenance, total flow volume since the last preventative maintenance, pressure of the hydrocarbon flow within the measurement station, and pressure cycles of the hydrocarbon flow. The constituents of hydrocarbons upon which a preventative maintenance decision may be made may comprise, for example, hydrocarbon type (e.g., natural gas, refined gasoline, refined diesel), presence of sand of the hydrocarbon flow, the type and amount of sand, presence of sulfides in the hydrocarbon flow (e.g., hydrogen sulfide), presence of water in the hydrocarbon flow, and presence of wax in the hydrocarbon flow. The atmospheric or environmental factors upon which preventative maintenance decision may be made may comprise, for example, temperature of the atmosphere surrounding the measurement station, sand or dust content of the environment surrounding the measurement station, humidity, corrosiveness of the environment surrounding the measurement station, and precipitation amount and type, affecting both field and control room components.

In accordance with the various embodiments, the measurement station 100 acquires information regarding constituents of hydrocarbons that flow through the measurement station. In some cases, some or all of the information regarding constituents of hydrocarbons is supplied to the measurement station by way of the human/machine interface 122. In other cases, at least some of the information regarding constituents of hydrocarbons may be acquired by reference to other components of the measurement station, such as the gas chromatograph 150. Regardless of the source, the measurement station 100 acquires information regarding constituents of the hydrocarbons, and utilizes the information in determining whether maintenance is indicated for physical components of the measurement station.

Also in accordance with the various embodiments, the measurement station 100 designer acquires information regarding physical components of the measurement station. In some cases, some or all of the information regarding physical components of the measurement station is supplied to the measurement station by way of the human/machine interface 122. The measurement station 100 designer acquires information regarding the physical components, and utilizes the information in determining whether maintenance is indicated for physical components of the measurement station.

In some cases, some or all the information regarding the atmospheric conditions is supplied to the measurement station by way of the human/machine interface 122. In other cases, at least some of the information regarding the atmospheric conditions may be acquired by reference to other components of the measurement station, such as by reference to temperature transmitters or thermocouples that measure outside temperature. Regardless of the source, the measurement station 100 acquires information regarding the atmospheric conditions, and utilizes the information in determining whether maintenance is indicated for physical components of the measurement station.

The specification now turns to an illustrative method of determining or calculating that maintenance is indicated for one or more physical components. In particular, in the various embodiments at least some physical components of the measurement station, and/or subcomponents thereof, are each associated with a respective maintenance parameter that has a value. The value of each maintenance parameter is indicative of the need for maintenance for the associated physical component. For example, each meter device 104 and 106 may have a respective maintenance parameter, each valve 112, 114, 116 and 118 may have a respective maintenance parameter, the piping within the measurement station may have a maintenance parameter, and the electronic devices (e.g., flow computer, metrological unit, gateway, ultrasonic meter electronics) may have respective maintenance parameters. As time passes and/or as hydrocarbons flow through the measurement station, the value of each respective maintenance parameter is adjusted. When a particular maintenance parameter value reaches or approaches a predetermined value, then the measurement station 100 may alert the user that maintenance is indicated.

In accordance with the various embodiments, each value of the maintenance parameters is adjusted based on one or more of the parameters of the hydrocarbon flow, constituents of the hydrocarbons, the atmospheric conditions within which the measurement station resides, and/or time. Consider, as an example, that meter device 104 has a maintenance parameter, and meter device 106 has a maintenance parameter. At times when hydrocarbons flow through meter device 104 and not meter device 106, the value of the maintenance parameter for the meter device 104 may be adjusted at a different rate than the value of the maintenance parameter for meter device 106. In some cases, when there is no hydrocarbon flow through a meter device, the value of the maintenance parameter may remain unchanged.

As yet another example of adjusting of values of maintenance parameters, consider a situation where a first hydrocarbon flow having a first set of constituents flows through meter device 104. During the period of time of the first hydrocarbon flow, the value of the maintenance parameter for the meter device 104 is adjusted at a particular rate (e.g., based on the amount of time the hydrocarbons flow, the volume of hydrocarbons that move through the meter device, and/or the constituents of the hydrocarbons). At some point thereafter, the first hydrocarbon flow ceases, and a second hydrocarbon flow having a second set of constituents flows through the meter device 104. For example, the source of hydrocarbons may change based on valve position changes for valves 180 and 182. During the period of time of the second hydrocarbon flow, the value of the maintenance parameter is adjusted at a rate different than the rate for the first hydrocarbon flow (e.g., based on the amount of time the hydrocarbons flow, the volume of hydrocarbons that move through the meter device, and/or the constituents of the hydrocarbons).

More particularly still, consider that the first hydrocarbon flow has very little entrained sand, but the second hydrocarbon flow has a high sand content. If the amount of time of hydrocarbon flow is equal, and the volume of each hydrocarbon flow is also equal, the rates at which the value of the maintenance parameter are adjusted are nevertheless different to account for the higher abrasive effect of the sand in the second hydrocarbon flow. Meter devices 104 and 106 are merely illustrative of physical components for which maintenance parameters may be maintained, and are presented as merely exemplary of how the values of the maintenance parameters may be adjusted.

In at least some embodiments, maintenance parameters are dimensionless values, and the maintenance parameters may be adjusted up or down toward the specific predetermined value. For example, in some embodiments a maintenance parameter may be initialized to a particular value (e.g., 1000) and the value may be decreased at a rate based on the parameters of hydrocarbon flow, constituents of the hydrocarbons, the atmospheric conditions within which the measurement station operates, and/or time. When the maintenance parameter reaches a predetermined value (e.g., zero), then the measurement station 100 may provide an indication on the operator interface. In other embodiments, the value of a maintenance parameter may start at a low value (e.g., zero) and the value may be increased at a rate based on the parameters of hydrocarbon flow, constituents of the hydrocarbons, the atmospheric conditions within which the measurement station operates, and/or time. When the maintenance parameter reaches a predetermined value (e.g., 1000), then the measurement station 100 may provide an indication on the operator interface.

Although in some embodiments the maintenance parameters may be dimensionless values, in other embodiments the maintenance parameters may be loosely associated with particular units. For example, a maintenance parameter may be initiated to a particular time value (e.g., 2000 hours) and the value may be decreased at a rate based on parameters of hydrocarbon flow, constituents of the hydrocarbons, atmospheric conditions within which the measurement station operates, and/or time. It is noted, however, that the units of the maintenance parameter do not limit the rate at which the maintenance parameter may be adjusted. For example, the value of the maintenance parameter for the meter device may be adjusted down two “hours” for single hour of flow with hydrocarbons having particular constituents (e.g., high amounts of entrained sand). Further still, the value of the maintenance parameter for the meter device may be adjusted down two “hours” for single hour of flow when a high volume of hydrocarbons flow through the meter, yet adjusted down only a half “hour” when a low volume of the same hydrocarbons flow through the meter device. Thus, even if maintenance parameters are assigned units (e.g., hours, days, months, volume) to aid in conceptualizing their meaning, the units do not dictate the rate of adjustment.

Although there would be a benefit to the measurement station 100 owner if the measurement station only gave an indication that maintenance was indicated for specific components, in yet still further embodiments the measurement station not only provides the indication that maintenance is indicated on the specific components, but also provides specific actions regarding that should be performed. Table 1 below provides an illustrative list of meter types for measured hydrocarbon, flow variables, and considerations to highlight the many combinations possible for measurement station variables to be considered when providing the specific actions regarding the specific components.

TABLE 1
Flow Medium

Gas
Pressure differential
Ultrasonic
Coriolis
GC
Liquid
Pressure differential
Ultrasonic
Turbine
Coriolis

Variables

Gas
Pressure
Pressure cycles
Moisture content
Sulfide content
Particulate content
Entrained water
Temperature
Liquid
Viscosity
Vapor pressure
Wax content
Sulfide content
Particulate content
Temperature
Cycles
Control Room
Temperature
Dust
Sand
Humidity
Atmosphere
Corrosive
Sand
Salt laden
Temperature
Snow
Humidity

Considerations

Sense lines
Bleed lines
Hydroscopic seals
Erosion
Corrosion
Transducers
Stem seals
Bolt Torque
Gaskets
Orifice plates
Flow conditioners
Packing seals
Blocking seals
Thermowell
Valve stems
Filters
Elastomer compression
Elastomer brittleness
Turbine fittings
Coatings
Grounding

Table 1 is not intended to be all inclusive; rather, Table 1 merely provides illustrative variables and considerations for each physical component.

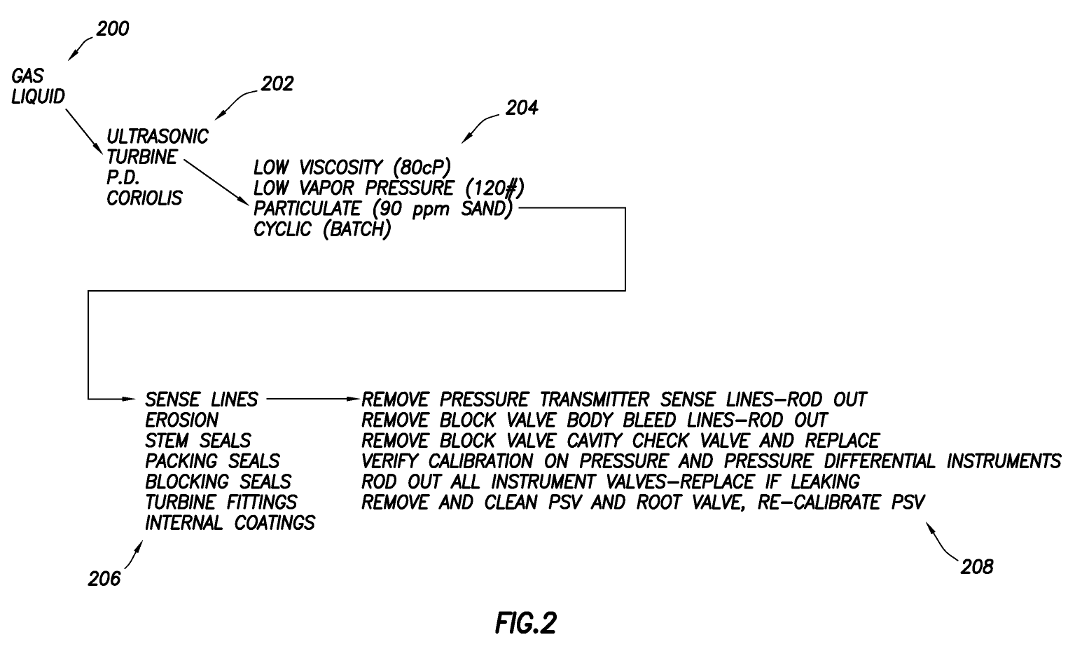

Consider, as an example, the illustration of FIG. 2 applying some of the information from Table 1. In particular, FIG. 2 illustrates a situation where the flow medium is a liquid hydrocarbon (200), and the liquid hydrocarbon flows through a turbine-type meter (202). The illustrative variables are that the liquid hydrocarbon has low viscosity, low vapor pressure, a 90 part per million (PPM) sand content, and the measurement station experiences pressure cycles (204) because of “batch” mode operation. The particular illustrative situation affects the sense lines, stem seals, packing seals, blocking seals, turbine fittings, internal coatings, and causes erosion (206). In accordance with embodiments that provide indications that specific action regarding the specific components should be performed, each consideration entry has particular actions. In the example of FIG. 2, the affect on the sense lines leads to an indication that (208): pressure transmitter sense lines should be cleaned (rod out); block valve bleed lines should be cleaned (rod out); block valve cavity check valve should be removed and replaced; calibration of the pressure and differential pressure transmitters should be verified; instrument valves should be cleaned (rod out) and/or replaced; and the PSV and root valve should be removed, cleaned and recalibrated. Though not specifically shown in FIG. 2, each entry in column 206 has a corresponding set of proposed actions which the measurement station 100 may recommend, such as by way of the human/machine interface 122.

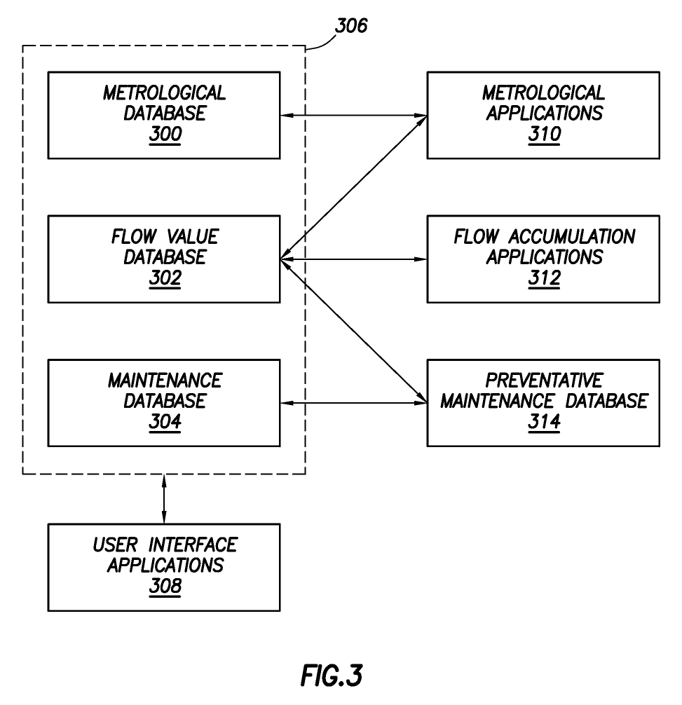

FIG. 3 shows an illustrative set of applications and databases that may be implemented by measurement station 100. The one or more databases that contain the respective values of the maintenance parameters and proposed actions, as well as the applications that adjust the maintenance parameters and send indications to the human/machine interface, may reside within any processing unit of the measurement station 100. More particularly, measurement station 100 may implement a metrological database 300, within which the data values needed for metrological functions, such as audit trails, are maintained. The measurement station may also comprise a database of flow values 302, within which various flow values determined by the measurement station are maintained, and which may also maintain accumulated values, such as station totals. The measurement station 100 in accordance with the various embodiments also has a maintenance database 304. The maintenance database may be the location where the various values of the maintenance parameters are stored, along with proposed actions, and to which location adjusted values are written when adjustments are made.

In some embodiments the various databases 300, 302 and 304 need not be co-located. For example, the metrological database 300 may reside on the metrological unit 136, and the flow value database 302 and maintenance database 304 may reside on computer systems other than the metrological database 136, such as the human/machine interface 122. Conversely, although FIG. 3 shows the various databases 300, 302 and 304 as individual databases, the various values may be stored in a single database 306 at any suitable location, such as within the metrological unit 136. In accordance with at least some embodiments, the databases 306 may be acted upon not only by applications that execute within the metrological unit 136, but also by applications executed on other processing units (such as processing unit 128 of the human/machine interface 122) over the backbone communication network 120.

Thus, one or more applications interact with some or all the various databases to implement the overall measurement station functionality. For example, one or more user interface applications 308 may interface with the databases 306 to facilitate user access to the data. More particularly, the user interface applications 308 may execute on the human/machine interface 122, and enable the user or operator to see information such as the current hydrocarbon flow values, accumulated volume from a predetermined point in the past, and indications of which meter runs are currently active. By way of the user interface applications 308 not only can particular values be accessed for viewing, but some values may be modified.

Still referring to FIG. 3, the measurement station may further comprise one or more metrological applications 310. The metrological applications interface with the databases 306 to facilitate the metrological functions. For example, changes made to control and/or metering aspects of the measurement station 100 by way of the user interface applications 308 are noted by the metrological application 310 in the metrological database 300 for the purpose of creating audit trails. In accordance with at least some embodiments, at least one metrological application 310 executes within the metrological unit 136, but the metrological applications 310 may execute in any suitable processing unit of the measurement station 100.

The measurement station may further comprise one or more flow accumulation applications 312. The flow accumulation applications interface with the flow computer 102 to accumulate flow data, and place the flow data in the flow value database 302. For example, the flow accumulation applications 312 may read the accumulated or summed flow volumes is calculated by the flow computer 102, and likewise place the accumulated volumes the flow value database 302. In accordance with at least some embodiments, at least one flow accumulation application 312 executes within the metrological unit 136, but the flow accumulation applications 312 may execute in any suitable processing unit of the measurement station 100.

Still referring to FIG. 3, the measurement station 100 may further comprise one or more preventative maintenance applications 314. The preventative maintenance applications 314 create and adjust the values of maintenance parameters maintained for a plurality of physical components of the measurement station, pass indications that maintenance is indicated to the human/machine interface 122, and also pass indications of proposed specific tasks to be performed to the human/machine interface 122. Thus, the preventative maintenance applications 314 may access any of the databases 306. In some cases the values of the maintenance parameters are merely overwritten with adjusted values, but in other cases the maintenance database 304 maintains historical information regarding the maintenance parameters. The historical values may be used, for example, to determine the historical rate of adjustment of a maintenance parameter to be used for predicting when preventative maintenance will be due. In accordance with at least some embodiments, the one or more preventative maintenance applications 314 execute within the metrological unit 136, but the maintenance applications 314 may execute in any suitable processing unit of the measurement station 100.

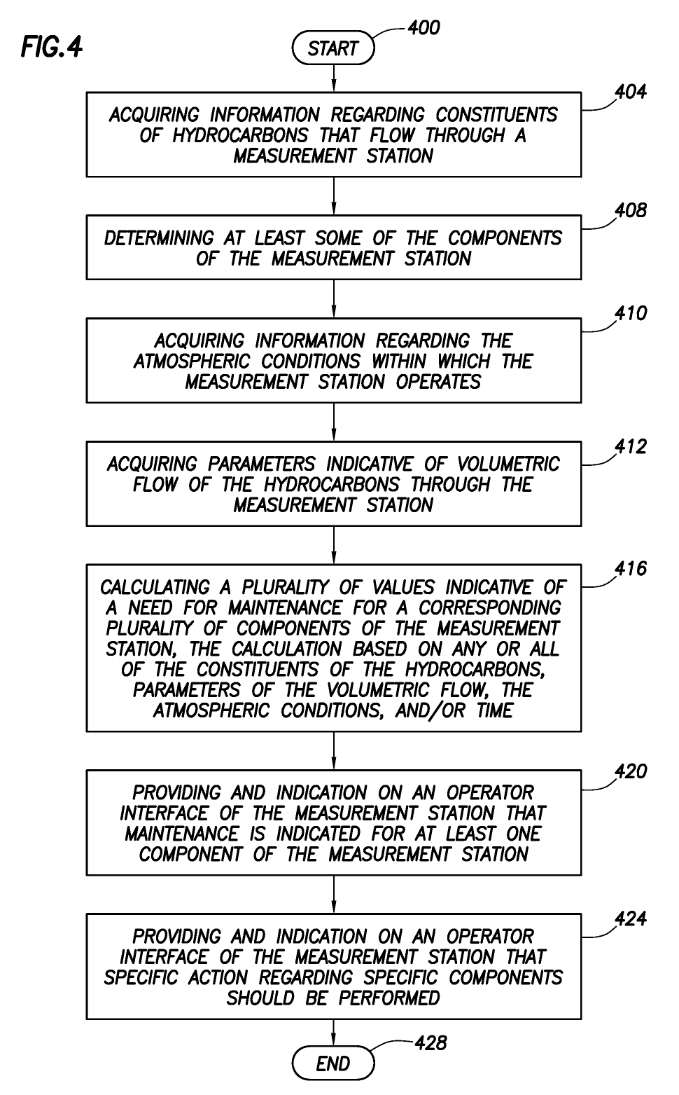

FIG. 4 illustrates a method in accordance with at least some embodiments. The various method steps of FIG. 4 are merely illustrative. The steps may be performed in an order different than shown in FIG. 4, the steps may be combined, and various steps may be omitted, and yet the benefits of the invention still achieved. Thus, the illustrative steps, and the order, shown in FIG. 4 should not be construed as a limitation as to the breath of the invention. In particular, the method starts (block 400) and proceeds to acquiring information regarding constituents of hydrocarbons that flow through a measurement station (block 404). In some cases, acquiring the information is by electronic communication to devices within the measurement station, such as the gas chromatograph 150. In other cases, the acquiring is by way of an operator interface, such as the human/machine interface 122. Next, the illustrative method moves to determining at least some of the components of the measurement station (block 408). In some cases, determining at least some of the components is by electronic communication to devices within the measurement station, such as the gas chromatograph 150, flow computer 102, and/or gateway 124. The ability to communication with such devices indicates their presence, but the existence of other components may be discovered or inferred from such devices. In other cases, the determining is by way of an operator interface, such as the human/machine interface 122.

Next, the illustrative method proceeds to acquiring information regarding the atmospheric conditions within which the measurement station operates (block 410). The acquiring is by way of an operator interface, such as the human/machine interface 122.

The illustrative method moves to acquiring parameters indicative of volumetric flow of the hydrocarbons through the measurement station (block 412), and calculating a plurality of values indicative of a need for maintenance for a corresponding plurality of components of the measurement station, the calculation based on any or all of the constituents of the hydrocarbons, parameters of the volumetric flow, the atmospheric conditions, and/or time (block 416). As discussed above, the calculating may take many forms. The values may be based on previous values, and may be adjusted up or down. Moreover, the calculating may change some values at faster rates than other values. Based on the plurality of values, the illustrative method moves to providing an indication on an operator interface of the measurement station that maintenance is indicated for at least one component of the measurement station (block 420), providing an indication on an operator interface of the measurement station that specific action regarding specific components should be performed (block 424), and the method ends (block 428).

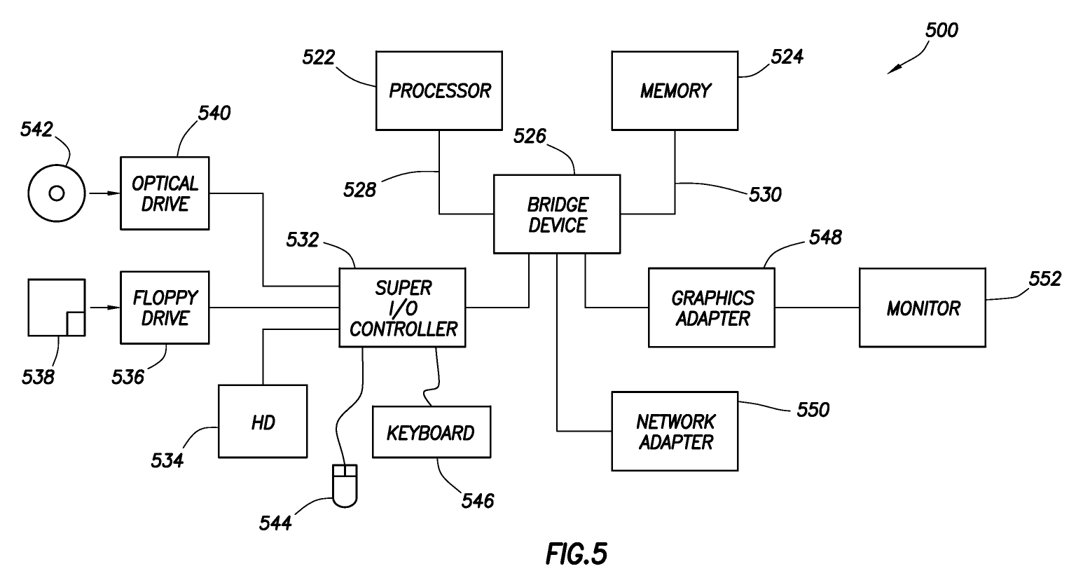

FIG. 5 illustrates a processing unit 500 in accordance with at least some embodiments. The processing unit 500 could be any of the processing units of FIG. 1, such as the processing unit 138 (associated with the metrological unit 136), processing unit 128 (associated with the human/machine interface 122), gateway 124, flow computer 102 or gas chromatograph 150. In particular, the processing unit 500 comprises a processor 522 coupled to a memory device 524 by way of a bridge device 526. Although only one processor 522 is shown, multiple processor systems, and system where the “processor” has multiple processing cores, may be equivalently implemented.

The processor 522 couples to the bridge device 526 by way of a processor bus 528, and memory 524 couples to the bridge device 526 by way of a memory bus 530. Memory 524 is any volatile or any non-volatile memory device, or array of memory devices, such as random access memory (RAM) devices, dynamic RAM (DRAM) devices, static DRAM (SDRAM) devices, double-data rate DRAM (DDR DRAM) devices, or magnetic RAM (MRAM) devices.

The bridge device 526 comprises a memory controller and asserts control signals for reading and writing of the memory 524, the reading and writing both by processor 522 and by other devices coupled to the bridge device 526 (i.e., direct memory access (DMA)). The memory 524 is the working memory for the processor 522, which stores programs executed by the processor 522 and which stores data structures used by the programs executed on the processor 522. In some cases, the programs held in the memory 524 are copied from other devices (e.g., hard drive 534 discussed below or from other non-volatile memory) prior to execution.

Bridge device 526 not only bridges the processor 522 to the memory 524, but also bridges the processor 522 and memory 524 to other devices. For example, the illustrative processing unit 500 may comprise an input/output (I/O) controller 532 which interfaces various I/O devices to the processing unit 500. In the illustrative processing unit 500, the I/O controller 532 enables coupling and use of non-volatile memory devices such as a hard drive (HD) 534, “floppy” drive 536 (and corresponding “floppy disk” 538), an optical drive 540 (and corresponding optical disk 542) (e.g., compact disk (CD), digital versatile disk (DVD)), and also enables coupling of a pointing device or 544, and a keyboard 536. In the case of processing unit 500 being a processing unit associated with the human/machine interface 122, the keyboard 546 and pointing device 544 may correspond to the keyboard 132 and pointing device 134, respectively, of FIG. 1. In the case of processing unit 500 being a processing unit associated with the metrological unit 136, the keyboard 546 and pointing device 544 may correspond to the keyboard 142 and pointing device 144, respectively, of FIG. 1. In situations where the processing unit 500 of FIG. 5 is a flow computer 102, gas chromatograph 150 or gateway 124, the keyboard 546 and pointing device 544 may be omitted. In the case of processing unit 500 being flow computer 102, gas chromatograph 150 or gateway 124, additionally the hard drive 534, floppy drive 536 and optical drive 540 may be omitted. Further still, in the case of processing unit 500 being the processing unit 138 associated with the metrological unit 136, the I/O controller 532 may be replaced by a multiple drive controller, such as a drive controller for a Redundant Array of Inexpensive Disks (RAID) system.

Still referring to FIG. 5, the bridge device 526 further bridges the processor 522 and memory 524 to other devices, such as a graphics adapter 548 and communication port or network adapter 550. Graphics adapter 548, if present, is any suitable graphics adapter for reading display memory and driving a display device or monitor 552 with graphic images represented in the display memory. In some embodiments, the graphics adapter 548 internally comprises a memory area to which graphic primitives are written by the processor 522 and/or DMA writes between the memory 524 and the graphics adapter 548. The graphics adapter 548 couples to the bridge device 526 by way of any suitable bus system, such as peripheral components interconnect (PCI) bus or an advance graphics port (AGP) bus. In some embodiments, the graphics adapter 548 is integral with the bridge device 526. The human/machine interface 122 and the metrological unit 136 of FIG. 1 may each comprise the graphics adapter, while the flow computer 102, gas chromatograph 150 and gateway 124 may omit the graphics adapter.

Network adapter 550 enables the processing unit 500 to communicate with other processing units over the backbone computer network 120 (FIG. 1). In some embodiments, the network adapter 550 provides access by way of a hardwired connection (e.g., Ethernet network), and in other embodiments the network adapter 550 provides access through a wireless networking protocol (e.g., IEEE 802.11(b), (g)).

Programs implemented and executed to convert the various computers into special purposes machines to perform the illustrative methods discussed above may be stored and/or executed from any of the computer-readable storage mediums of the illustrative processing unit 500 (e.g., memory 524, optical device 542, “floppy” device 538 or hard drive 534).

From the description provided herein, those skilled in the art are readily able to combine software created as described with appropriate computer hardware to create a special-purpose computer system and/or other computer subcomponents in accordance with the various embodiments, to create a special-purpose computer system and/or computer subcomponents for carrying out the methods for various embodiments, and/or to create a computer-readable storage medium or mediums for storing a software program, that, when executed by a processor, reverse the processor and the machine in which the processor operates into a special-purpose of machine.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system comprising:
a measurement station configured to measure volumetric flow of hydrocarbons, the measurement station comprising:
a flow meter fluidly coupled to a piping system configured to carry at least one type of hydrocarbon flow; and
a computer system comprising an interface device, the computer system electrically coupled to the flow meter and the computer system configured to maintain a plurality of parameters related to the volume of hydrocarbon flow in the piping;
the computer system configured to provide maintenance information for the measurement station, the computer system provides the maintenance information at intervals determined based on constituents of hydrocarbons and based on the parameters related to the volume of hydrocarbon flow in the piping.

2. The system of claim 1 wherein the computer system further comprises:
a first computer system configured to determine the plurality of parameters related to the volume of hydrocarbon flow in the piping; and
a second computer system coupled to the first computer system, the second computer system configured to provide the maintenance information for the measurement station.

3. The system of claim 1 wherein the computer system is configured to acquire information regarding the constituents of the hydrocarbons.

4. The system of claim 3 wherein the computer system is configured to acquire by accepting entry of parameters by way of the interface device.

5. The system of claim 3 wherein the computer system is configured to acquire by accepting parameters from a hydrocarbon analysis device.

6. The system of claim 1 wherein the computer system is configured to acquire information regarding a plurality of physical components of the measurement station, and further configured to provide the maintenance information for the plurality of physical components of the measurement station.

7. The system of claim 1 further comprising:
the piping is configured to carry a first type of hydrocarbon flow, and then carry a second type of hydrocarbon flow different than the first type of hydrocarbon flow;
the computer system is configured to provide the maintenance information at intervals based on a volume of the first type of hydrocarbon flow since a last maintenance was performed and a volume of the second type of hydrocarbon flow since the last maintenance was performed.

8. The system of claim 1 wherein the maintenance information is at least one selected from the group consisting of: an indication that maintenance should be performed; an indication that maintenance of specific components should be performed; and indication that specific action regarding specific components should be performed.

9. A method comprising:
acquiring information regarding constituents of hydrocarbons that flow through a measurement station;
acquiring parameters indicative of volumetric flow of the hydrocarbons through the measurement station;
calculating a value indicative of a need for maintenance for at least one component of the measurement station, the calculating by the measurement station based on the constituents of the hydrocarbons and the parameter of the volumetric flow; and responsive to the calculating
providing an indication on an operator interface of the measurement station that maintenance is indicated for at least one component of the measurement station.

10. The method of claim 9 wherein calculating further comprises:
adjusting, by the measurement station, the value indicative of the need for maintenance at a first rate for a first set of constituents of the hydrocarbons; and
adjusting, by the measurement station, the value indicative of the need for maintenance at a second rate, different than the first rate, for a second set of constituents of hydrocarbons, different than the first set of constituents of hydrocarbons.

11. The method of claim 10 wherein calculating further comprises adjusting the value based on volumetric flow of hydrocarbons.

12. The method of claim 10 wherein calculating further comprises adjusting the value based on an amount of time the hydrocarbons flow.

13. The method of claim 9 wherein providing the indication that maintenance is indicated further comprises providing an indication that maintenance is indicated on at least one selected from the group consisting of: a meter; a valve; a pipe; a pressure transmitter; a temperature transmitter; and a gas chromatograph.

14. The method of claim 9 wherein acquiring information regarding constituents further comprises accepting the information regarding constituents by way of the operator interface.

15. The method of claim 9 further comprising:
determining at least some components of the measurement station; and
wherein calculating further comprises calculating a plurality of values indicative of the need for maintenance, at least some of the plurality of values correspond to the at least some components of the measurement station.

16. A computer-readable medium storing instructions that, when executed by a processor within a hydrocarbon measurement station, cause the processor to:
acquire information regarding constituents of hydrocarbons that flow through the hydrocarbon measurement station;
acquire parameters indicative of volumetric flow of the hydrocarbons;
calculate a plurality of values indicative of a need for maintenance for a corresponding plurality of components of the measurement station, the calculation based on the constituents of the hydrocarbons and the parameters of the volumetric flow; and based on the plurality of values provide an indication on an operator interface of the measurement station that maintenance is indicated for at least one component of the measurement station.

17. The computer-readable medium of claim 16 wherein when processor calculates, the program further causes the processor to:
adjust at least some of the plurality of values indicative of the need for maintenance at a first rate for a first set of constituents of the hydrocarbons; and
adjust at least some of the plurality of values indicative of the need for maintenance at a second rate, different than the first rate, for a second set of constituents of hydrocarbons, different than the first set of constituents of hydrocarbons.

18. The computer-readable medium of claim 17 wherein when the processor calculates, the program causes the processor to adjust at least some of the plurality of values based on volumetric flow of hydrocarbons.

19. The computer-readable medium of claim 17 wherein when the processor calculates, the program causes the processor to adjust at least some of the plurality of values based on an amount of time the hydrocarbons flow.

20. The computer-readable medium of claim 16 wherein when the processor provides, the program further causes the process to provide an indication that maintenance is indicated on at least one selected from the group consisting of: a meter; a valve; a pipe; a pressure transmitter; a temperature transmitter; and a gas chromatograph.

21. The computer-readable medium of claim 16 wherein when the processor acquires, the program further causes the processor to accept the information regarding constituents by way of the operator interface.
